(19) United States
(12) Patent Application Publication
(10) Pub. No.: US 2011/0253670 A1
(43) Pub. Date: Oct. 20, 2011

(54) METHODS FOR ETCHING SILICON-BASED ANTIREFLECTIVE LAYERS

(75) Inventors: YIFENG ZHOU, Sunnyvale, CA (US); QINGJUN ZHOU, San Jose, CA (US); RYAN PATZ, Albany, NY (US); JEREMIAH T. PENDER, San Jose, CA (US); MICHAEL D. ARMACOST, San Jose, CA (US)

(73) Assignee: APPLIED MATERIALS, INC., Santa Clara, CA (US)

(21) Appl. No.: 12/896,389

(22) Filed: Oct. 1, 2010

Related U.S. Application Data
(60) Provisional application No. 61/325,493, filed on Apr. 19, 2010.

(51) Int. Cl. B01J 19/00

(52) U.S. Cl. 216/47

(57) ABSTRACT

Methods for etching silicon-based antireflective layers are provided herein. In some embodiments, a method of etching a silicon-based antireflective layer may include providing to a process chamber a substrate having a multiple-layer resist thereon, the multiple-layer resist comprising a patterned photoresist layer defining features to be etched into the substrate disposed above a silicon-based antireflective coating; and etching the silicon-based antireflective layer through the patterned photoresist layer using a plasma formed from a process gas having a primary reactive agent comprising a chlorine-containing gas. In some embodiments, the chlorine-containing gas is chlorine (Cl₂).

### CROSS-REFERENCE TO RELATED APPLICATIONS

This application claims benefit of U.S. provisional patent application Ser. No. 61/325,493, filed Apr. 19, 2010, which is herein incorporated by reference.

### FIELD

Embodiments of the present invention generally relate to semiconductor processing and, more particularly, to methods of etching silicon-based antireflective layers.

### BACKGROUND

Integrated circuits have evolved into complex devices that can include millions of components (e.g., transistors, capacitors and resistors) on a single chip. The evolution of chip designs continually requires faster circuitry and greater circuit density. The demands for greater circuit density necessitate a reduction in the dimensions of the integrated circuit components.

The overall size of the integrated circuit components are limited by the smallest geometrical feature that can be etched into the substrate, the critical dimension (CD). One technique for etching features into a substrate utilizes an etch mask to facilitate greater control of the critical dimension. Conventional etch mask fabrication utilizes a multi-step process to successively etch layers of a multi-layer resist. The multi-layer resist may include, for example, a photoresist layer and one or more antireflective layers, wherein at least one of the antireflective layers is a silicon-based antireflective coating (Si-ARC). Conventionally, the silicon-based antireflective coating is etched using a plasma formed from a fluorocarbon based etch chemistry. However, the inventors have observed that the use of fluorocarbon based etch chemistry provides inadequate control over the critical dimensions of the features.

Therefore, the inventors have provided an improved method of etching silicon-based antireflective coatings.

### SUMMARY

Methods for etching silicon-based antireflective layers are provided herein. In some embodiments, a method of etching a silicon-based antireflective layer may include providing to a process chamber a substrate having a multiple-layer resist thereon, the multiple-layer resist comprising a patterned photoresist layer defining features to be etched into the substrate disposed above a silicon-based antireflective coating; and etching the silicon-based antireflective layer through the patterned photoresist layer using a plasma formed from a process gas having a primary reactive agent comprising a chlorine-containing gas. In some embodiments, the chlorine-containing gas is chlorine (Cl₂).

Other embodiments and variations are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only exemplary embodiments of this invention and are therefore not to be considered limiting of its scope, for the invention may admit to other equally effective embodiments.

FIG. 1 depicts a method for the processing of a semiconductor substrate in accordance with some embodiments of the present invention.

FIGS. 2A-2C are illustrative cross-sectional views of a substrate during different stages of the processing sequence in accordance with some embodiments of the present invention.

FIG. 3 depicts an apparatus suitable for processing semiconductor substrates in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods for etching silicon-based antireflective layers. The inventive methods may advantageously increase productivity and efficiency of processing substrates by providing a silicon-containing antireflective coating etch process that allows for a reduction in the critical dimension of etched features. The inventive methods may further advantageously increase productivity and efficiency of processing substrates by providing an increased etch rate of silicon-containing antireflective layers compared to conventional techniques.

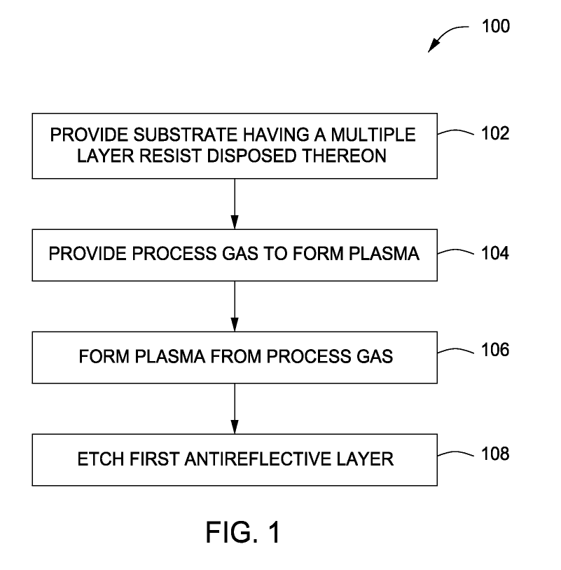

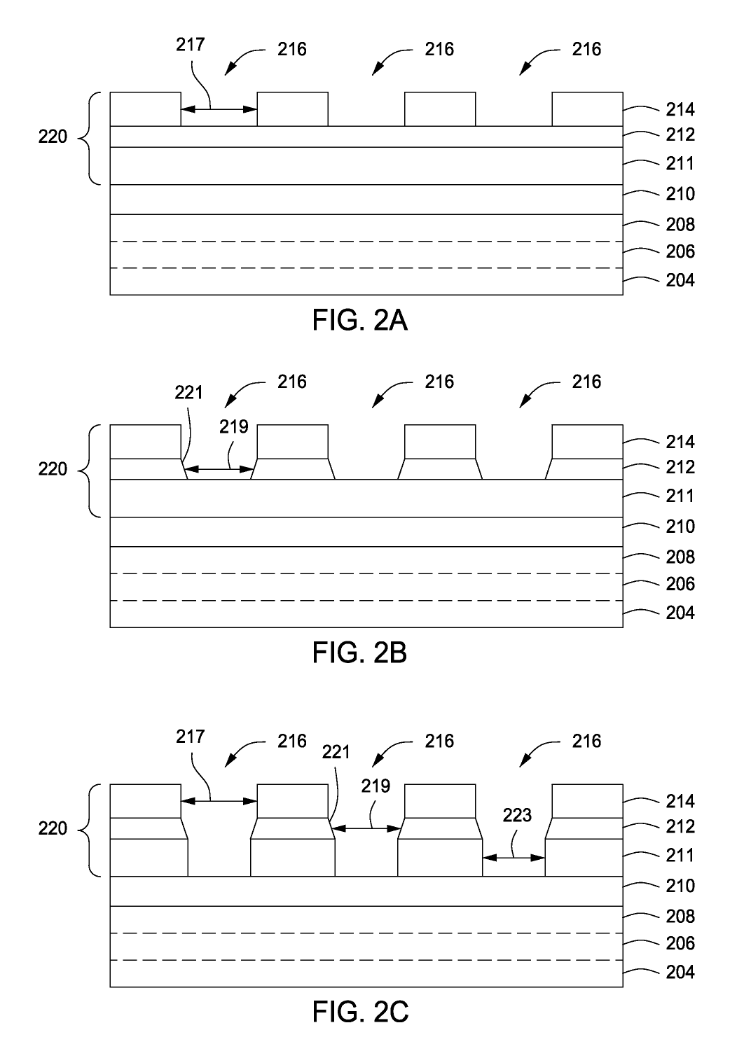

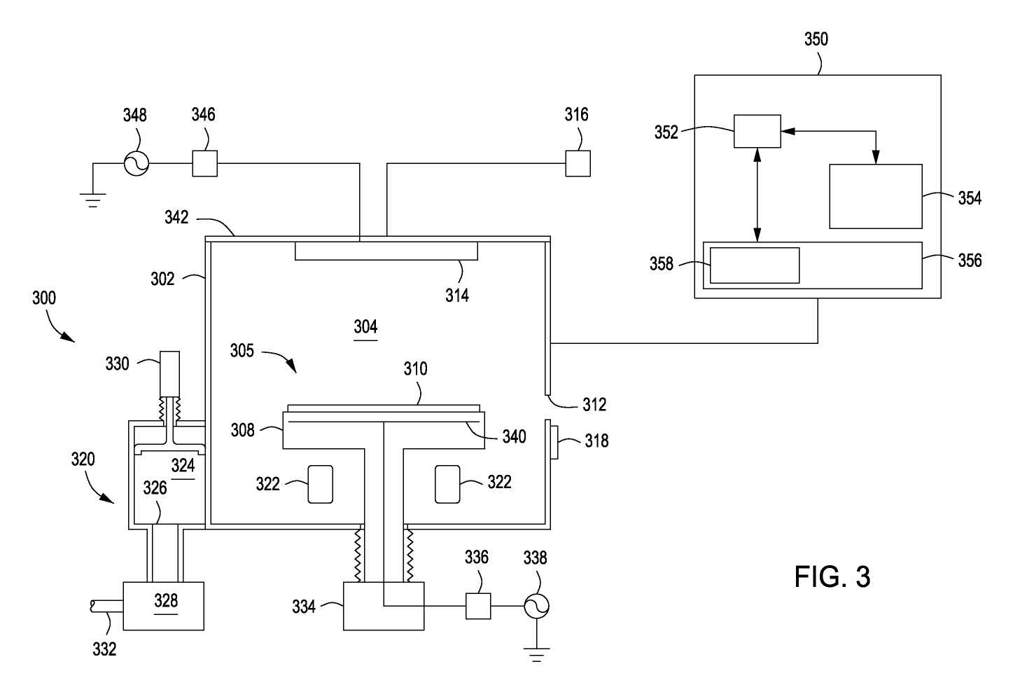

FIG. 1 depicts a method for the processing of a substrate in accordance with some embodiments of the present invention. The method 100 described herein may advantageously be performed in a processing chamber, such as described below with respect to FIG. 3. FIGS. 2A-2C are illustrative cross-sectional views of a substrate during different stages of the process sequence in accordance with some embodiments of the present invention. To best understand the invention, the reader should refer simultaneously to FIG. 1 and FIGS. 2A-2C.

The method 100 generally begins at 102, wherein a substrate 204, having a multi-layer resist 220 disposed thereon is provided, as depicted in FIG. 2A. The multi-layer resist 220 may comprise a first antireflective layer 212, a second antireflective layer 211, and a photoresist layer 214. The photoresist layer 214 may be patterned to have openings defining features 216 of a desired geometry having suitable dimensions (e.g., the critical dimension 217), as depicted in FIGS. 2A-C.

The substrate 204 may be any suitable substrate, such as a silicon substrate, a III-V compound substrate, a silicon germanium (SiGe) substrate, an epi-substrate, a silicon-on-insulator (SOI) substrate, a display substrate such as a liquid crystal display (LCD), a plasma display, an electro luminescence (EL) lamp display, a light emitting diode (LED) substrate, a solar cell array, solar panel, or the like. In some embodiments, the substrate 204 may be a semiconductor wafer (e.g., a 200 mm, 300 mm, or the like silicon wafer). In some embodiments, the substrate 204 may include additional layers, for example one or more (two shown) dielectric layers 206, 208. In such embodiments, the dielectric layers 206, 208 may comprise dielectric materials having a dielectric constant less than 4.0 (e.g., low-k materials). Non-limiting examples of suitable dielectric materials include carbon-containing silicon oxides (SiOC), such as BLACK DIAMOND® dielectric material available from Applied Materials, Inc., and other low-k polymers, such as polyamides. In some embodiments, the dielectric layers 206, 208 are carbon-containing silicon oxide (SiOC) layers.

Alternatively, or in combination, in some embodiments, one or both of the dielectric layers 206, 208 may have a dielectric constant of about 5.5 or less. In such embodiments, for example, the dielectric layer 206 may comprise a carbon containing silicon layer (SiC), a nitrogen doped carbon containing silicon layer (SiCN), or the like. In some embodiments, the dielectric layer 206 is a SiCN film. A non-limiting example of one suitable dielectric layer material is BLOK® dielectric material, available from Applied Materials, Inc. In addition, features, such as trenches, vias, or the like, may be formed in one or more layers of the substrate 204.

In some embodiments, one or more intervening layers (such as layer 210) may be disposed between the multi-layer resist 220 and the substrate 204 to facilitate the etch process. In some embodiments, the intervening layer 210 may include a polycrystalline silicon layer and/or a tunnel oxide layer.

In some embodiments, a hard mask layer (not shown) may be disposed between the multi-layer resist 220 and the substrate 204 to facilitate improved control over etch dimensions. In such embodiments, the hard mask layer may comprise any hard mask material suitable to be used to facilitate etching a pattern or feature into a substrate 204. For example, in some embodiments, the hard mask layer may be a metal hard mask layer, for example a titanium nitride (TiN) hard mask layer. The hard mask layer may be formed over the substrate 204 in any suitable manner, such as by chemical vapor deposition (CVD), physical vapor deposition (PVD), or the like.

The photoresist layer 214 may comprise any suitable photoresist, such as a positive or negative photoresist that may be formed and patterned in any suitable manner as known in the art. The first and second antireflective layers 212, 211 are provided to facilitate improved control over the patterning of the substrate 204. For example, in some embodiments, such as depicted in FIGS. 2A-C, the first antireflective layer 212 may be disposed beneath the photoresist layer 214, and the second antireflective layer 211 may be disposed beneath the first antireflective layer 212. The first and second antireflective layers 212, 211 may comprise any materials suitable to provide an adequate amount of control over the subsequent patterning processes and may be formed in any suitable manner as known in the art.

In some embodiments, the first antireflective layer 212 is a silicon-based antireflective coating comprising a silicon-based material, for example, silicon nitride (SiN), silicon oxynitride (SiON), silicon carbide (SiC), and the like. In some embodiments, the second antireflective layer 211 may be fabricated from an organic material. For example, the second antireflective layer 211 may comprise organic materials such as polyamides, polysulfones, and the like.

Next, at 104, a process gas used to form a plasma may be provided. In some embodiments, the process gas may comprise a chlorine-containing gas as the primary reactive agent. In some embodiments, the chlorine-containing gas is chlorine (Cl₂). The use of chlorine (Cl₂) as a primary reactive agent may facilitate an increased etching rate, for example, in some embodiments, greater than about twice the etching rate of a conventional fluorocarbon-based antireflective layer etch. In addition, the inventors have unexpectedly discovered that, in some applications, features etched into the first antireflective layer may be formed with a tapered profile when using chlorine as the primary reactive agent in accordance with the teachings provided herein. Thus, the inventive methods may be used to desirably provide a feature having a reduced critical dimension proximate a bottom of the feature as compared to proximate the top of the feature (or as compared to the critical dimension of a feature in an overlying layer through which the first antireflective layer is being etched). In some embodiments, the process gas may be provided at a flow rate of between about 5 to about 500 sccm, or about 50 sccm. In embodiments where the first process gas comprises chlorine (Cl₂) as the only reactive gas, such gases may be provided at the flow rates disclosed above.

In some embodiments, the process gas may additionally comprise one or more additives to promote plasma stability, for example, at least one of, oxygen (O₂), hydrogen (H₂), a fluorocarbon (CₓF_{y}), or a hydrofluorocarbon (CₓH_{y}F_{z}). In embodiments where one or more additives are included in the first process gas, the flow rate ratio of reactive agents to additives may be about 1:0.1 to about 1:10, or about 1:0.5.

In embodiments where a fluorocarbon is included as an additive, a fluorocarbon-containing gas may be provided that comprises gases that dissociate to form F radicals and CFₓ (where x is a positive integer), such as CF₄, C₂F₆, C₄F₈, or the like. In some embodiments, a hydrofluorocarbon-containing gas may be provided that comprises gases that dissociate to form F radicals and CFₓ, as well as that provides hydrogen (H) that combines with the free fluorine in the plasma to increase the C:F ratio (or C:H:F ratio), such as CH₂F₂, CH₄, CHF₃, or the like. The ratio of C:F (or C:H:F) facilitates control of the properties of the plasma (although the bias power, described below, may also be supplied to also influence this behavior).

Optionally, a dilutant gas may be provided with the process gas. The dilutant gas may be any inert gas, such as nitrogen (N₂), helium (He), Argon (Ar), or the like. In some embodiments, the dilutant gas may be provided at a flow rate of between about 10 to about 500 sccm, or in some embodiments, about 80 sccm.

Next at 106, the first process gas may be formed into a plasma by coupling RF power at a suitable frequency to the process gas mixture within a process chamber under suitable conditions to establish and maintain the plasma, such as described below with respect to FIG. 3. For example, in some embodiments, a plasma power source of up to about 500 W, or between about 50 to about 2000 W, or about 300 W, at a frequency in a range from 50 kHz to 13.56 MHz may be provided to ignite and maintain the plasma.

Additional process parameters may be utilized to promote plasma ignition and stability. For example, in some embodiments, the process chamber may be maintained at a temperature of between about 20 to about 60 degrees Celsius during plasma ignition and etching. Additionally, in some embodiments, the process chamber may be maintained at a pressure of between about 10 to about 500 mTorr, such as about 80 mTorr.

Next, at 108, the first antireflective layer 212 is etched using the plasma formed from the process gas to form one or more features in the first antireflective layer 212, such as the features 216, as depicted in 2B. Generally, to facilitate etching, high energy ions from the plasma are accelerated towards the substrate 204, causing material to be ejected from the first antireflective layer 212, thereby etching the desired features 216 into the first antireflective layer 212. In some embodiments, the ions may be directed toward the substrate 204 via a self bias formed on the substrate 204 resulting from the application of RF power to the process gas to form the plasma, as discussed above. Alternatively, or in combination, to facilitate directing the ions towards the substrate 204 an additional bias power may be provided to the substrate 204 via a substrate support disposed in a process chamber, for example, such as discussed below with respect to FIG. 3. For example, in such embodiments, the bias power may be about 20 to about 1000 W, at a frequency in a range from 50 kHz to 13.56 MHz.

As discussed above with respect to the composition of the process gases at 104, the use of chlorine as a primary reactant may facilitate having a profile comprising tapered sidewalls 221, as depicted in FIG. 2B. By providing the tapered sidewalls 221, the critical dimension 217 of the feature 216 may advantageously be reduced, resulting in a smaller critical dimension 219.

Upon completion of first antireflective layer 212 etch at 108, the method 100 generally ends. Underlying layers, for example, the second antireflective layer 211, intervening layer 210 and dielectric layers 204, 206 may be subsequently processed by one or more additional process steps to complete the devices and/or structures being fabricated on the substrate. For example, a subsequent etch process may be performed to etch the feature 216 through the first antireflective layer 212 into the second antireflective layer 211, as depicted in FIG. 2C. The first antireflective layer 212 may serve as a template for the subsequent etch process, advantageously providing a feature 216 having reduced critical dimension 219 due to the tapered sidewalls 221 etched into first antireflective layer 212. The tapered sidewalls 221 allows for a further reduction in the critical dimension of the feature 216, thereby effectively shrinking the critical dimension 217 formed in the photo resist layer 214 to the critical dimension 223 of the feature 216 etched into the second antireflective layer 211. Although only a number of features 216 are depicted in FIGS. 2A-C, the inventive methods are suitable for use in connection with forming single or dual damascene structures, contacts, vias, trenches, or any other feature or pattern as desired.

FIG. 3 depicts an apparatus 300 suitable for processing a substrate in accordance with some embodiments of the present invention. The apparatus 300 may comprise a controller 350 and a process chamber 302 having an exhaust system 320 for removing excess process gases, processing by-products, or the like, from the interior of the process chamber 305. Exemplary process chambers may include the DPS®, ENABLER®, ADVANTEDGE™, or other process chambers, available from Applied Materials, Inc. of Santa Clara, Calif. Other suitable process chambers may similarly be used.

The process chamber 302 has an inner volume 305 that may include a processing volume 304. The processing volume 304 may be defined, for example, between a substrate support pedestal 308 disposed within the process chamber 302 for supporting a substrate 310 thereupon during processing and one or more gas inlets, such as a showerhead 314 and/or nozzles provided at desired locations. In some embodiments, the substrate support pedestal 308 may include a mechanism that retains or supports the substrate 310 on the surface of the substrate support pedestal 308, such as an electrostatic chuck, a vacuum chuck, a substrate retaining clamp, or the like (not shown). In some embodiments, the substrate support pedestal 308 may include mechanisms for controlling the substrate temperature (such as heating and/or cooling devices, not shown) and/or for controlling the species flux and/or ion energy proximate the substrate surface.

For example, in some embodiments, the substrate support pedestal 308 may include an RF bias electrode 340. The RF bias electrode 340 may be coupled to one or more bias power sources (one bias power source 338 shown) through one or more respective matching networks (matching network 336 shown). The one or more bias power sources may be capable of producing up to 12,000 W at a frequency of about 2 MHz, or about 13.56 MHz, or about 60 Mhz. In some embodiments, two bias power sources may be provided for coupling RF power through respective matching networks to the RF bias electrode 340 at respective frequencies of about 2 MHz and about 13.56 MHz. In some embodiments, three bias power sources may be provided for coupling RF power through respective matching networks to the RF bias electrode 340 at respective frequencies of about 2 MHz, about 13.56 MHz, and about 60 Mhz. The at least one bias power source may provide either continuous or pulsed power. In some embodiments, the bias power source alternatively may be a DC or pulsed DC source.

The substrate 310 may enter the process chamber 302 via an opening 312 in a wall of the process chamber 302. The opening 312 may be selectively sealed via a slit valve 318, or other mechanism for selectively providing access to the interior of the chamber through the opening 312. The substrate support pedestal 308 may be coupled to a lift mechanism 334 that may control the position of the substrate support pedestal 308 between a lower position (as shown) suitable for transferring substrates into and out of the chamber via the opening 312 and a selectable upper position suitable for processing. The process position may be selected to maximize process uniformity for a particular process. When in at least one of the elevated processing positions, the substrate support pedestal 308 may be disposed above the opening 312 to provide a symmetrical processing region.

The one or more gas inlets (e.g., the showerhead 314) may be coupled to a gas supply 316 for providing one or more process gases into the processing volume 304 of the process chamber 302. Although a showerhead 314 is shown in FIG. 3, additional or alternative gas inlets may be provided such as nozzles or inlets disposed in the ceiling or on the sidewalls of the process chamber 302 or at other locations suitable for providing gases as desired to the process chamber 302, such as the base of the process chamber, the periphery of the substrate support pedestal, or the like.

In some embodiments, the apparatus 300 may utilize capacitively coupled RF power for plasma processing, although the apparatus may also or alternatively use inductive coupling of RF power for plasma processing. For example, the process chamber 302 may have a ceiling 342 made from dielectric materials and a showerhead 314 that is at least partially conductive to provide an RF electrode (or a separate RF electrode may be provided). The showerhead 314 (or other RF electrode) may be coupled to one or more RF power sources (one RF power source 348 shown) through one or more respective matching networks (matching network 346 shown). The one or more plasma sources may be capable of producing up to about 5,000 W at a frequency of about 2 MHz and or about 13.56 MHz or high frequency, such as 27 MHz and/or 60 MHz.

The exhaust system 320 generally includes a pumping plenum 324 and one or more conduits that couple the pumping plenum 324 to the inner volume 305 (and generally, the processing volume 304) of the process chamber 302, for example via one or more inlets 322 (two inlets shown in FIG. 3). A vacuum pump 328 may be coupled to the pumping plenum 324 via a pumping port 326 for pumping out the exhaust gases from the process chamber 302. The vacuum pump 328 may be fluidly coupled to an exhaust outlet 332 for routing the exhaust as required to appropriate exhaust handling equipment. A valve 330 (such as a gate valve, or the like) may be disposed in the pumping plenum 324 to facilitate control of the flow rate of the exhaust gases in combination with the operation of the vacuum pump 328. Although a z-motion gate valve is shown, any suitable, process compatible valve for controlling the flow of the exhaust may be utilized.

To facilitate control of the process chamber 302 as described above, the controller 350 may be one of any form of general-purpose computer processor that can be used in an industrial setting for controlling various chambers and sub-processors. The memory, or computer-readable medium, 356 of the CPU 352 may be one or more of readily available memory such as random access memory (RAM), read only memory (ROM), floppy disk, hard disk, or any other form of digital storage, local or remote. The support circuits 354 are coupled to the CPU 352 for supporting the processor in a conventional manner. These circuits include cache, power supplies, clock circuits, input/output circuitry and subsystems, and the like.

The inventive methods disclosed herein may generally be stored in the memory 356 as a software routine 358 that, when executed by the CPU 352, causes the process chamber 302 to perform processes of the present invention. The software routine 358 may also be stored and/or executed by a second CPU (not shown) that is remotely located from the hardware being controlled by the CPU 352. Some or all of the method of the present invention may also be performed in hardware. As such, the invention may be implemented in software and executed using a computer system, in hardware as, e.g., an application specific integrated circuit or other type of hardware implementation, or as a combination of software and hardware. The software routine 358 may be executed after the substrate 310 is positioned on the pedestal 308. The software routine 358, when executed by the CPU 352, transforms the general purpose computer into a specific purpose computer (controller) 350 that controls the chamber operation such that the methods disclosed herein are performed.

While the foregoing is directed to embodiments of the present invention, other and further embodiments of the invention may be devised without departing from the basic scope thereof.

1. A method for etching a silicon-based antireflective layer, comprising:
providing to a process chamber a substrate having a multiple-layer resist thereon, the multiple-layer resist comprising a patterned photoresist layer defining features to be etched into the substrate disposed above a silicon-based antireflective coating; and
etching the silicon-based antireflective layer through the patterned photoresist layer using a plasma formed from a process gas having a primary reactive agent comprising a chlorine-containing gas.

2. The method of claim 1, wherein the silicon-based antireflective layer comprises silicon nitride (SiN), silicon oxynitride (SiON), or silicon carbide (SiC).

3. The method of claim 1, wherein the substrate further comprises an oxide layer disposed below the silicon-based antireflective layer.

4. The method of claim 1, wherein the substrate further comprises at least one dielectric layer disposed below the silicon-based antireflective layer.

5. The method of claim 4, wherein the at least one dielectric layers comprise two dielectric layers, wherein at least one of the two dielectric layers has a dielectric constant of less than 4.

6. The method of claim 1, wherein the multiple-layer resist further comprises an organic layer disposed below the silicon-based antireflective coating.

7. The method of claim 1, wherein forming the plasma comprises:
providing the process gas to the process chamber at a flow rate of about 5 to about 500 sccm.
igniting the process gas using a plasma power source to form the plasma.

8. The method of claim 7, wherein the plasma power source is provided at a power of about 50 to about 2000 W.

9. The method of claim 1, wherein the chlorine-containing gas is chlorine (Cl₂).

10. The method of claim 1, wherein the process gas further comprises an additive comprising one of oxygen (O₂), hydrogen (H₂), a fluorocarbon, or a hydrofluorocarbon.

11. The method of claim 10, wherein the additive includes the fluorocarbon and the fluorocarbon comprises at least one of tetrafluoromethane (CF₄), hexafluoroethane (C₂F₆) or octafluorocyclobutane (O₄F₈).

12. The method of claim 10, wherein the additive include the hydrofluorocarbon and the hydrofluorocarbon comprises at least one of difluoromethane (CH₂F₂), methane (CH₄), or trifluoromethane (CHF₃),

13. The method of claim 10, wherein the flow rate ratio of the additive to the chlorine-containing gas is about 1:0.1 to about 1:10.

14. The method of claim 1, wherein forming the plasma further comprises providing an inert gas with the process gas.

15. The method of claim 14, wherein the inert gas is one of nitrogen (N₂), helium (He), or argon (Ar).

16. The method of claim 14, wherein the inert gas is provided at a flow rate of about 10 to about 500 sccm.

17. The method of claim 1, further comprising:
maintaining a temperature of about 20 to about 60 degrees Celsius in the process chamber while forming the plasma and etching the silicon-based antireflective layer.

18. The method of claim 1, further comprising:
maintaining a pressure of about 10 to about 500 mTorr in the process chamber while forming the plasma and etching the silicon-based antireflective layer.

19. The method of claim 1, further comprising:
applying a bias power to the substrate of about 20 to about 1000 W while etching the silicon-based antireflective layer at a frequency of about 50 kHz to about 13.56 MHz.

20. The method of claim 1, wherein etching the silicon-based antireflective further comprises:
forming a tapered sidewall in the silicon-based antireflective layer to provide a smaller critical dimension proximate a bottom portion of the silicon-based antireflective layer as compared to a critical dimension of the patterned photoresist layer.
